(19) United States
(12) Patent Application Publication
(10) Pub. No.: US 2004/0090705 A1
(43) Pub. Date: May 13, 2004

(54) Magnetic head including recording device and servo device, and magnetic recording apparatus and magnetic recording/reproducing apparatus including the magnetic head

(75) Inventor: Katsuya Kikuiri, Niigata-ken (JP)

Correspondence Address: Brinks Hofer Gilson & Lione, P.O. Box 10395, Chicago, IL, 60610, US

(73) Assignee: Alps Electric Co., Ltd.

(21) Appl. No.: 10/702,340

(22) Filed: Nov. 6, 2003

(30) Foreign Application Priority Data
Nov. 13, 2002 (JP) 2002-329829

(51) Int. Cl. G11B 5/147; G11B 5/41; G06F 12/14

(52) U.S. Cl. 360/126; 360/128; 360/321; 711/162

(57) ABSTRACT

A magnetic recording/reproducing apparatus includes a servo head amplifier, including first and second signal processors, comparator circuit, and tape speed controller. The first signal processor processes a first signal read from first servo device into a third signal, and the second signal processor processes a second signal read from second servo device into a fourth signal. The comparator circuit compares the third and fourth signals. If a signal output difference exists, the tape speed controller changes the magnetic tape transport speed, so that a signal is recorded to form a signal track with constant width. Therefore, it is possible to provide a magnetic head capable of stably recording signals to form signal tracks with constant width using servo technology, a magnetic recording apparatus including the magnetic head, and a magnetic recording/reproducing apparatus which can stably record signals to form signal tracks with constant width and restrict variations in reproduction signals.

### BACKGROUND OF THE INVENTION

1. Field of the Invention

The present invention relates to, for example, a magnetic recording apparatus of a video system for recording a recording signal onto a magnetic tape, and a data magnetic recording apparatus for a computer. More particularly, the present invention relates to a magnetic head which can stably record signals to form tracks with constant width using servo technology when performing a recording operation on a magnetic recording medium, and a magnetic recording apparatus and a magnetic recording/reproducing apparatus including the magnetic head.

2. Description of the Related Art

In, for example, a magnetic recording apparatus of a video system and a magnetic recording/reproducing apparatus for storing computer data, a magnetic head is installed at a rotating drum of a rotating head device, a magnetic tape comes into contact with the rotating drum and is transported in a helical path, and the rotating drum rotates to perform a recording operation on the magnetic tape by a helical scanning method.

In a reproducing operation, since it is important for the magnetic head to precisely trace a recording pattern, a reproducing head is generally formed so as to follow a data track, with a track which has servo information recorded on it being a reference position.

Reproducing heads have been conventionally variously designed so that they can precisely trace signal tracks in a reproducing operation.

Japanese Unexamined Patent Application Publication No. 2001-23125, European Patent No. 1204096, and U.S. Pat. Nos. 5,713,122 and 5,745,978 should be referred to.

In recent years, an increase in recording density has decreased the width of signal tracks. Nowadays, the signal track width is down to approximately 2.0 μm.

When track width is decreased, depending upon, for example, the mechanical precision of a rotating drum or the precision with which tilting of a magnetic head is adjusted, variations occur in the width of a track during recording. Accordingly, the recording operation tends to be performed with variations in the width of a track. As a result, even if a reproducing head precisely traces a signal track while reading an area where a servo signal is recorded, variations occur in a reproduction signal.

### SUMMARY OF THE INVENTION

Accordingly, the present invention has been achieved to overcome the aforementioned problems, and has as its object the provision of, in particular, a magnetic head which can stably record signals to form signal tracks with constant width using servo technology when performing a recording operation on a magnetic recording medium, a magnetic recording apparatus including the magnetic head, and a magnetic recording/reproducing apparatus which can stably record signals to form signal tracks with constant width and can restrict variations in reproduction signals.

Accordingly, according to a first aspect of the present invention, there is provided a magnetic head for recording signals to form adjacent signal tracks of a magnetic recording medium at different azimuth angles and for recording signals to form alternately-adjacent signal tracks of the magnetic recording medium at the same azimuth angle. The magnetic head comprises a recording device, and a servo device disposed in parallel with the recording device in a direction in which the magnetic head moves over the magnetic recording medium. In the magnetic head, while the recording device is recording signals to form a signal track on the magnetic recording medium at a certain azimuth angle, the servo device moves over a signal track that has already been formed at the same azimuth angle as the certain azimuth angle by recording a signal.

According to the present invention, it is possible to stably record signals to form signal tracks with constant width with the recording device by signal track reading by the servo device. Therefore, when a signal recorded on any of the signal tracks is reproduced with a reproducing device that is installed in a magnetic head that is different from the aforementioned magnetic head or a reproducing device that is installed in the aforementioned magnetic head including the recording device and the servo device, it is possible to output a reproduction signal with little variation.

According to the present invention, the recording device and the servo device of the magnetic head are disposed in parallel in the direction of movement of the magnetic head over the magnetic recording medium. While the recording device is recording a signal onto the recording medium at a certain azimuth angle, the servo device moves over a signal track which has already been formed with an azimuth angle that is the same as the certain azimuth angle by recording a signal.

By virtue of this structure, by using a track that has already been formed by recording a signal as a servo area, and disposing the servo device and the recording device at suitable positions so that the servo device can move over a signal track formed with an azimuth angle that is the same as the azimuth angle of the recording device, the servo device can move over a signal track formed with an azimuth angle that is the same as the azimuth angle of the recording device. Therefore, based the size of an output signal obtained from the servo device, the recording device can perform a recording operation while correcting any shifts in the recording device from a track whenever necessary. Consequently, it is possible to stably record signals to form signal tracks with constant width.

In the present invention, from the viewpoints of reducing the size of the magnetic head and making it easier to dispose the recording device and the servo device, it is desirable that the servo device move over a signal track formed by recording a first signal immediately before a current recording of a second signal on the magnetic recording medium by the recording device, the first signal being recorded by the same recording device used for the second signal that is currently being recorded.

In the present invention, from the viewpoint of reducing the width of signal tracks, it is desirable for the servo device to be a magneto-resistive (MR) thin-film magnetic head.

In the present invention, it is desirable that the magnetic head further comprise a reproducing device that overlaps the recording device in the thickness direction. In addition, it is desirable that the reproducing device be a magneto-resistive (MR) thin-film magnetic head.

According to a second aspect of the present invention, there is provided a magnetic recording apparatus comprising the magnetic head, servo amplifying means, and servo executing means. The servo amplifying means is used for processing and outputting a signal read from the servo device that has moved over a signal track in a certain recording operation, and for processing and outputting a signal read from the servo device in a currently carried out recording operation on the magnetic recording medium. The servo executing means comprises a comparator circuit and a recording device movement position correcting means, the comparator circuit being used to compare levels of the outputs.

If there is a difference between the output level of a signal read from the servo device in a certain recording operation and the output level of a signal read from the servo device of the magnetic head currently performing a recording operation, a determination is made that the recording device is not shifted from a certain track. On the other hand, if there is a difference between the output levels, a determination is made that the recording device is shifted from the certain track. In such a case, since the position of movement of the recording device with respect to the magnetic recording medium is corrected whenever necessary by, for example, changing the transport speed of the magnetic recording medium, even if a problem occurs in, for example, the precision of a mechanical system, it is possible to record signals to form signal tracks with constant width at all times. In the present invention, the magnetic recording apparatus incorporates an electrical circuit that can record signals to form signal tracks with constant width at the time of recording.

According to a third aspect of the present invention, there is provided a magnetic recording/reproducing apparatus comprising the magnetic head, a servo amplifying means, and servo executing means. The magnetic head comprises a recording device, a servo device, and a reproducing device. The servo amplifying means is used for processing and outputting a signal read from the servo device that has moved over a signal track in a certain recording operation, and for processing and outputting a signal read from the servo device in a currently carried out recording operation on the magnetic recording medium. The servo executing means comprises a comparator circuit and a recording device movement position correcting means, the comparator circuit comparing levels of the outputs. In a reproducing operation, a signal read from the reproducing device is sent to the servo amplifying means and is output as a reproduction signal from the servo amplifying means, so that the servo amplifying means is used, not only as a servo circuit, but also as a reproduction circuit.

According to the above-described magnetic recording/reproducing apparatus, the servo amplifying means can be used not only as a servo circuit, but also as a reproducing circuit means. Therefore, it becomes easy to design circuits, and the number of parts and the size of the magnetic recording/reproducing apparatus can be reduced.

The magnetic recording/reproducing apparatus may further comprise reproduction amplifying means, disposed separately from the servo amplifying means, for outputting the signal read from the reproducing device. In the reproducing operation, the reproduction amplifying means outputs the signal read from the reproducing device as a reproduction signal, and the servo amplifying means outputs the signal read from the servo device as a reproduction signal.

By virtue of this structure, a signal read from the reproducing device in a reproducing operation is output as a reproduction signal, and a signal read from the servo device is also output as a reproduction signal. Therefore, it is possible to double the reproducing speed.

### BRIEF DESCRIPTION OF THE DRAWINGS

FIG. 1 is a conceptual diagram for illustrating the structure of a magnetic head of an embodiment of the present invention and the relationship between the position of movement of the magnetic head and the transport position of a magnetic tape;

FIG. 2 is a conceptual diagram for illustrating how to operate servo devices when a recording operation is performed;

FIG. 3 illustrates an example of a servo circuit and a recording circuit in the present invention;

FIG. 4 illustrates an example of a servo circuit, a recording circuit, and a reproducing circuit;

FIG. 5 illustrates an example of a servo circuit, a recording circuit, and a reproducing circuit;

FIG. 6 illustrates a rotating head device;

FIG. 7 illustrates a rotating head device that is different from that shown in FIG. 6;

FIG. 8 is a conceptual diagram for illustrating a state resulting from recording signals to form signal tracks of a magnetic tape with the magnetic head of the present invention; and

FIG. 9 is a partial sectional view of the magnetic head of the present invention as seen from its surface facing a medium.

### DESCRIPTION OF THE PREFERRED EMBODIMENTS

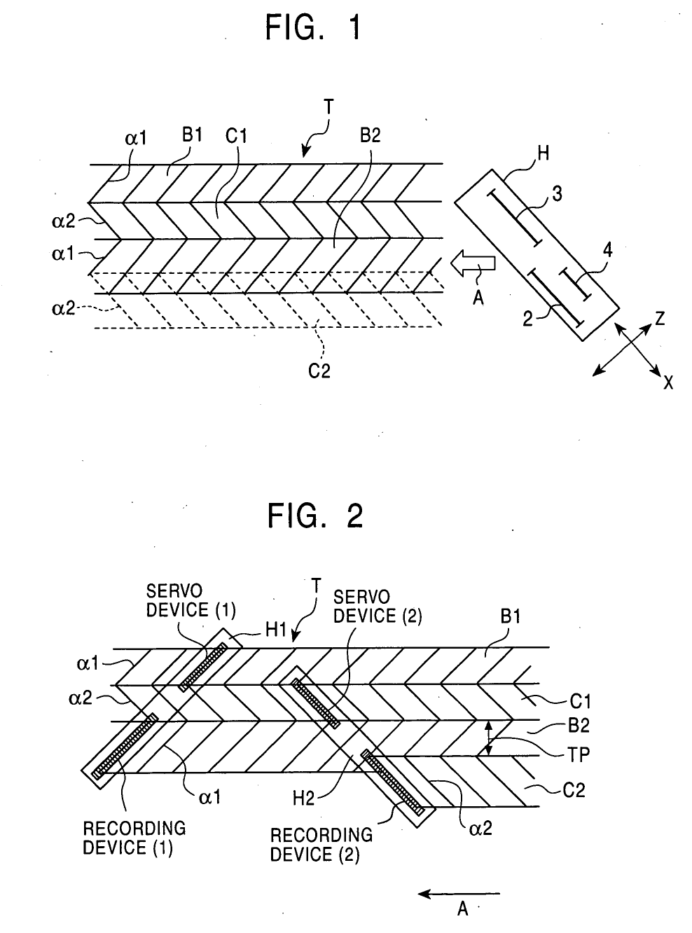

FIG. 1 is a conceptual diagram for illustrating a magnetic head of the present invention and the relationship between the position of the magnetic head and the position of a magnetic tape when the magnetic head moves over the magnetic tape.

A magnetic head H shown in FIG. 1 is a sliding magnetic head installed in, for example, a magnetic recording/reproducing device for a video system for recording a signal onto and reproducing the signal from a magnetic tape T, or a data magnetic recording/reproducing apparatus for a computer.

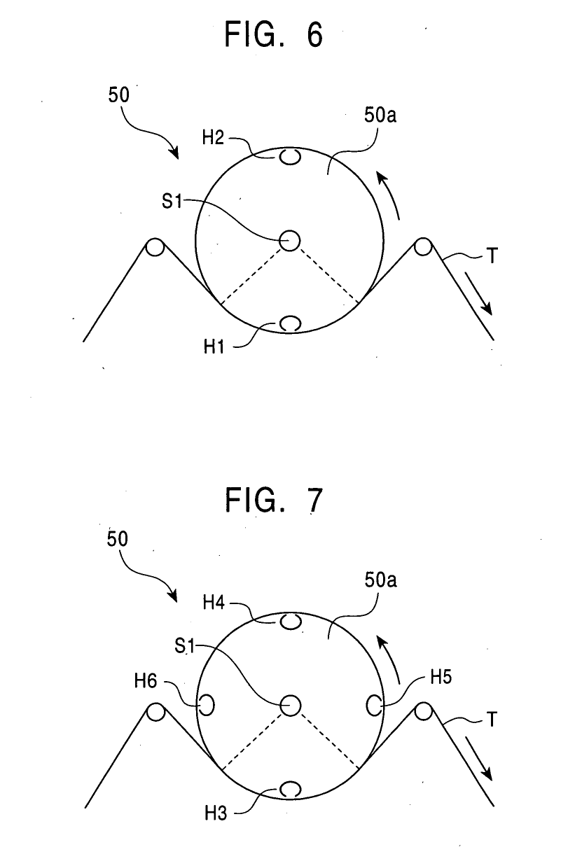

Magnetic heads H1 and H2 shown in FIG. 2 may be installed in a rotating head device shown in FIG. 6.

In a rotating head device 50 shown in FIG. 6 installed in a magnetic recording/reproducing apparatus, a stationary drum (not shown) is fixed, and a rotating drum 50a (which is coaxial with the stationary drum) is rotatably supported at the stationary drum and is rotationally driven by motor power in the direction of an arrow marked beside the rotating drum 50a shown in FIG. 6. The magnetic tape T, which is a magnetic recording medium, is wound upon the rotating head device 50 at a predetermined angle in a helical path and runs in the direction of an arrow marked beside the magnetic tape T. While the magnetic tape T is running, the rotating drum 50a rotates, and the sliding magnetic head H1, which is installed at the rotating drum 50a, scans the magnetic tape T.

Although, in FIG. 6, a pair of sliding magnetic heads H1 and H2 are installed at opposing locations of the rotating drum 50a, three or more sliding thin-film magnetic heads may be installed.

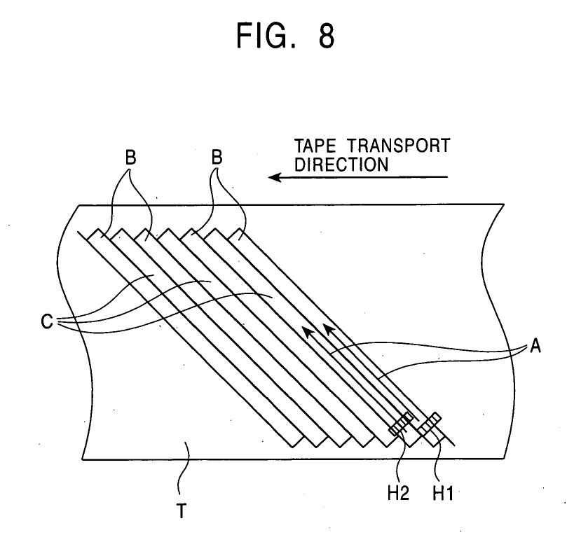

As shown in FIG. 8, the magnetic head H1 moves over an area of the magnetic tape T in the direction of arrow A. Then, the magnetic head H2 moves over the same area of the magnetic tape T in the direction of arrow A. As a result, signals are recorded to form a plurality of signal tracks B and tracks C of the magnetic tape T obliquely from the magnetic tape transport direction. The method in which signals are recorded to form signal tracks obliquely from the magnetic-tape-T transport direction is called a helical scanning method. In this method, since the magnetic heads H1 and H2 are formed at different azimuth angles, signals are recorded to form the signal tracks B and the signal tracks C adjacent thereto (shown in FIG. 8) with different azimuth angles. In other words, signals are recorded to form adjacent signal tracks B and C with different azimuth angles, and signals are recorded to form alternately-adjacent signal tracks (B and B, and C and C) with the same azimuth angles.

In the recording method illustrated in FIG. 8, guard bands are not formed between the signal tracks B and C (guard bandless recording method), so that signals are recorded to form the signal tracks B and C in such a manner that a portion of each of the signal tracks B and a portion of each of the adjacent signal tracks C overlap. By the degree of overlap, the widths of the signal tracks B and C are restricted to predetermined widths.

As shown in FIG. 1, the magnetic head H of the present invention comprises a recording device 2 and a servo device 3, which is disposed parallel with the recording device 2 (in the direction of arrow X in FIG. 1) with respect to a movement direction A of the magnetic head H over the magnetic tape T. In addition, as shown in FIG. 1, it is desirable that the magnetic head H further comprise a reproducing device 4, which overlaps the recording device 2 in the thickness direction (the direction of arrow Z in FIG. 1).

FIG. 1 shows a state in which the recording device 2 is trying to record a signal onto the magnetic tape T at an azimuth angle α2. At the time of the recording, the servo device 3 is above a signal track that has already been formed by recording a signal. Accordingly, the location of forming the servo device 3 is determined so that it moves over a signal track C1 that has already been formed with the same azimuth angle α2 by recording a signal.

At the time of recording, when the recording device 2 is recording a signal onto the magnetic tape T at the azimuth angle α2, the servo device 3 moves over the signal track C1 formed with the same azimuth angle α2, and reads a signal from the signal track C1. Based on the size of the signal output, the position of movement of the recording device 2 over the recording tape T is corrected whenever necessary, so that the recording device 2 is not shifted from a track. As a result, the recording device 2 can stably record a signal to form a signal track C2 with a constant width.

In FIG. 1, when the servo device 3 moves over the signal track C1 that has already been formed with the same azimuth angle α2 by recording a signal while the recording device 2 of the magnetic head H moves over the magnetic tape T, it is possible to perform a recording operation while performing a servo operation. In particular, even if another servo signal area is not provided, the signal track that has already been formed by recording a signal can be used as a servo area, so that the servo operation can be easily performed during the recording.

In the present invention, a recording operation is carried out while performing a servo operation during recording as described above. Therefore, even if, for example, there is a slight problem in the mechanical precision of the rotating head device 50 or magnetic head tilting adjustment is not performed between the two magnetic heads H1 and H2 shown in FIG. 6 with high precision, a signal is recorded to form a signal track while correcting any shifting of the recording device 2 from the track during recording. Therefore, a signal can be recorded to form a signal track with a constant width. Therefore, variations in a reproduction signal when the reproducing device 4 is reproducing the signal from the signal track rarely occurs.

In the present invention, it is desirable that the servo device 3 shown in FIG. 1 move over the signal track C1 that has already been formed by recording a signal immediately before a current recording of a signal onto the magnetic tape T by the recording device 2, the signal recorded on the signal track C1 being recorded by the same recording device 2 as that used for the signal currently being recorded. In FIG. 1, the signal tracks formed by recording signals by the same recording device 2 are signal tracks B1 and B2 or signal tracks C1 and C2. As shown in FIG. 1, when the signal track C2 is the track that is now being formed by recording a signal by the recording device 2 of the magnetic head H, the signal track that has been formed by recording a signal by the same recording device 2 is the signal track C1.

If the servo device 3 is such as to move over the signal track has been formed by recording a signal immediately before, the gap between the recording device 2 and the servo device 3 is reduced, so that the magnetic head H can be reduced in size. If the servo device 3 is such as to move over a signal track that has been formed by recording a signal before forming the signal track C1 by recording a signal, the number of signal tracks that can be formed by recording signals while performing a servo operation is reduced. Therefore, some of the signal tracks cannot be properly formed with a constant width. Consequently, it is desirable for the servo device 3 to move over the signal track C1 that has been formed by recording a signal immediately before a current recording of a signal onto the magnetic tape T by the recording device 2, with the signal that has been recorded immediately before being recorded by the same recording device 2 as that used for the signal currently being recorded.

The recording device 2, the servo device 3, and the reproducing device 4 of the magnetic head H shown in FIG. 1 may be formed using a thin-film technology.

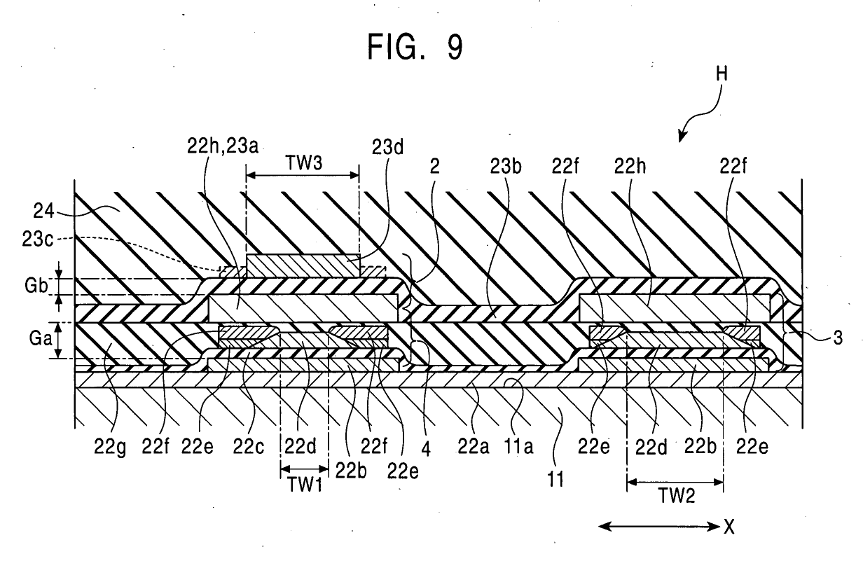

FIG. 9 is a partial sectional view of the magnetic head H of the present invention as seen from its surface facing a medium. In the magnetic head H, the reproducing device 4 and the servo device 3 are disposed on a surface 11a of a substrate 11, formed of alumina titan carbide, through an underlying layer, formed of an insulating material such as Al₂O₃ or SiO₂. The servo device 3 is disposed apart from the reproducing device 4 in the widthwise direction (direction of arrow X).

It is desirable that the reproducing device 4 and the servo device 3 both be magneto-resistive (MR) thin-film magnetic heads. As shown in FIG. 9, in each MR thin-film magnetic head 22, a lower shield layer 22b, a lower gap layer 22c, an MR device layer 22d, a hard bias layer 22e, an electrode layer 22f, an upper gap layer 22g, and an upper shield layer 22h are stacked upon each other on the substrate 11 through an insulating layer 22a, serving as the underlying layer. A portion that is disposed between the lower shield layer 22b and the upper shield layer 22h and that faces the magnetic tape is defined as a magnetic gap Ga of the reproducing device 4.

As shown in FIG. 9, the recording device 2 is disposed on the reproducing device 4, and is an inductive head formed by thin-film technology. As shown in FIG. 9, a gap layer 23b, a coil layer 23c, and an upper core layer 23d are stacked upon each other on a lower core layer 23a used as the upper shield layer. A portion that is formed between the lower core layer 23a and the upper core layer 23d and that opposes the magnetic tape is defined as a magnetic gap Gb of the recording device 2.

The lower gap layers 22c, the upper gap layers 22g, and the gap layer 23b are formed of Al₂O₃ or SiO₂. The lower shield layers 22b, the upper shield layers 22h (lower core layer 23a), and the upper core layer 23d are formed of soft magnetic materials such as permalloy. The electrode layers 22f and the coil layer 23c are formed of electrically conductive materials such as Cu. The hard bias layers 22e are formed of hard magnetic materials such as PtCo.

The MR device layers 22d are AMR devices or GMR devices such as a spin-valve thin-film device.

An insulating layer 24, which is a protective film, is stacked upon the inductive head 23.

When the recording device 2, the servo device 3, and the reproducing device 4 are formed using the aforementioned thin-film technology, the track width of each device is reduced, and signals can be recorded onto and reproduced from signal tracks of the magnetic tape T at a small pitch, so that the magnetic head H makes it possible to achieve high recording density.

Although the reproducing device 4 and the servo device 3 are both formed as MR thin-film magnetic heads as described above, as shown in FIG. 9, a track width Tw2 of the servo device 3 is larger than a track width Tw1 of the reproducing device 4.

When the servo device 3 is moving over a signal track, the servo device 3 is centered on the signal track based on an output read from the signal track. In addition, it detects the strength of the output to determine whether or not there are variations in the width of the signal track that it is currently moving over, so that, for example, the transport speed of the magnetic tape T is changed each time a variation occurs. Therefore, in order to precisely detect an output from a signal track, it is desirable for the track width Tw2 of the servo device 3 to fit in the width of the signal track.

In order to restrict cross-talk of adjacent tracks, it is desirable for the track width Tw1 of the reproducing device 4 to be smaller than the width of the signal tracks. Therefore, it is desirable for the track width Tw1 of the reproducing device 2 to be smaller than the track width Tw2 of the servo device 3.

In the servo device 3, the MR device layer 22d needs to be capable of detecting the strength of the magnetic field of a signal from a signal track. Therefore, it functions as a servo device even if the shield layers 22b and 22h, used for preventing entry of noise signals into the MR device layer 22d, and the hard bias layer 22e, used for forming a free magnetic layer (not shown), disposed in the MR device layer 22d, into a unidirectional single magnetic domain, are not formed. However, if, as described below, the servo device 3 is also used as a reproducing device or a more stable signal is required, it is desirable to form the shield layers 22b and 22h and the hard-bias layer 22.

As shown in FIG. 9, the track width of the recording device 2 is Tw3, which is larger than the track width Tw1 of the reproducing device 4.

With reference to FIG. 2 and the figures that follow, a specific example of performing a servo operation when recording will be described. FIG. 2 shows a state in which, after the magnetic head H1 comprising a servo device (1) and a recording device (1) has moved over the magnetic tape T in the direction of arrow A to a point shown in FIG. 2, the magnetic head H2 comprising a servo device (2) and a recording device (2) is still moving over the magnetic tape T in the direction of arrow A.

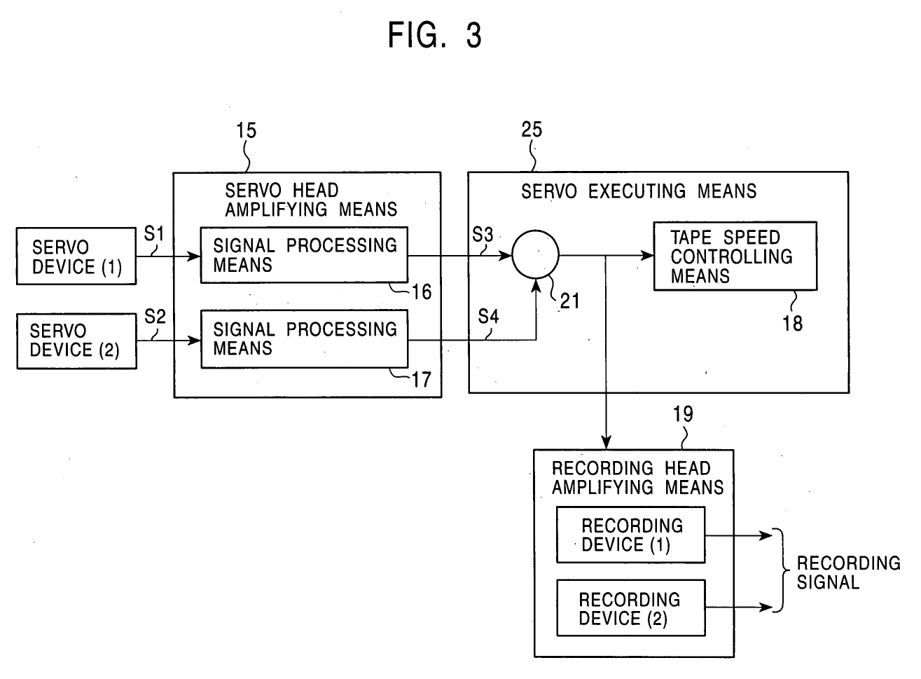

As shown in FIG. 2, the servo device (2), which is disposed at an azimuth angle α2 that is different from the azimuth angle at which the servo device (1) and the recording device (2) are disposed, moves over the signal track C1, adjacent the signal track B1, that has already been formed by recording a signal. At this time, as shown in FIG. 3, a signal S2 that is read as a result of the servo device (2) moving over the signal track C1 is sent to servo head amplifying means 15, which processes the signal S2 into a signal S4. Then, the servo amplifying means 15 sends the signal S4 to a comparator circuit 21 of servo executing means 25.

At this time, a signal S1, read by the servo device (1), has already been sent to signal processing means 16 of the servo head amplifying means 15, processed by the signal processing means 16 into a signal S3, and sent to the comparator circuit 21 as the signal S3.

The comparator circuit 21 compares an output level (1) of the signal S3 from the servo device (1) and an output level (2) of the signal S4 from the servo device (2). If these is no difference between the output levels (1) and (2), the comparator circuit 21 determines that the position of the moving recording device (2) is not shifted from a track, so that the recording device (2) of recording head amplifying means 19 outputs a recording signal while the transport speed of the magnetic tape T is kept the same.

On the other hand, if there is a difference between the output levels (1) and (2), the comparator circuit 21 determines that the position of the moving recording device (2) is shifted from the track. A signal indicating the shift is sent to tape speed controlling means 18 for adjusting magnetic tape speed in order to increase or decrease the magnetic-tape-T transport speed. While correcting the position of the moving recording device (2) whenever necessary, the recording device (2) of the recording head amplifying means 19 outputs a recording signal.

As described above, when the comparator circuit 21 compares the signals read from the servo devices at different times, and determines that there is a difference between the outputs, the position of the recording device above the magnetic tape is corrected while varying the magnetic tape transport speed. As a result, the signal track C2 that is formed by recording a signal as a result of the recording device (2) moving over the magnetic tape T, with a width TP of the signal track B2 being fixed and constant, by superimposing it upon the signal track B2 that has already been formed by recording a signal.

Regardless of what signal track the output level (1) originates from, the output level (1), which is read from the servo device (1), may be the first output level read from the servo device (1) in a recording operation or the output level of the signal track read from the servo device (1) in a previous recording operation.

Next, a description of how the servo head amplifying means 15, the servo executing means 25, and the head amplifying means 19 described with reference to FIG. 3 and the signal reproducing means using reproducing devices of the magnetic head are operatively associated in terms of time.

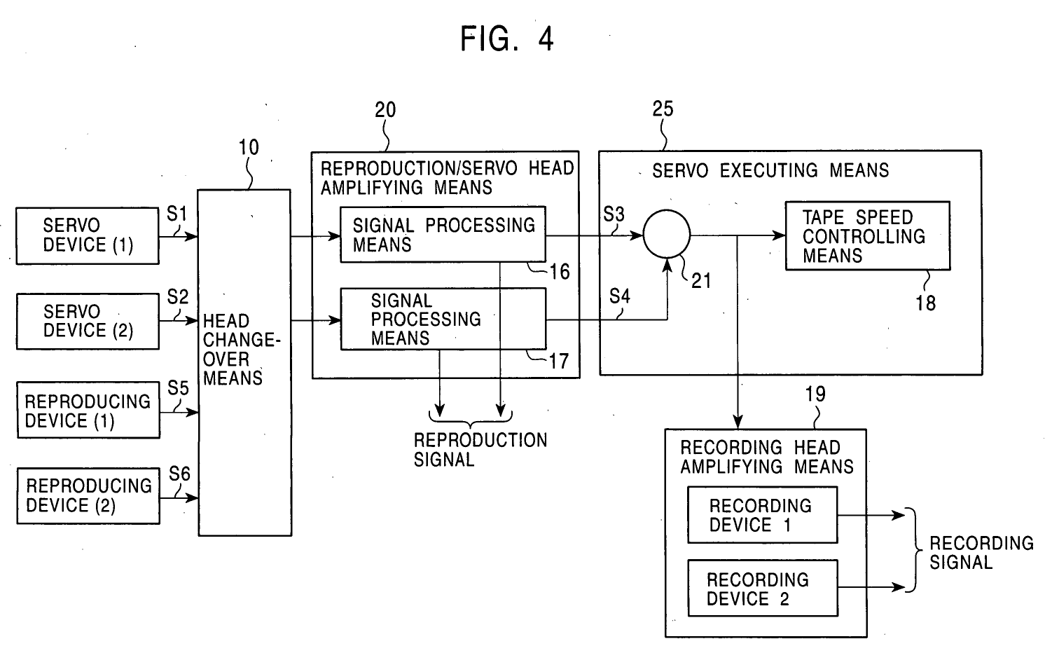

As shown in FIG. 4, servo devices (1) and (2) and reproducing devices (1) and (2) are all connected to head change-over means 10. Here, the servo device (1) and the reproducing device (1) are both installed in the same magnetic head H1 shown in FIG. 2, and the servo device (2) and the reproducing device (2) are installed in the same magnetic head H2. The servo device (1) and the reproducing device (1) move over a signal track (for example, an R channel) formed with an azimuth angle α1 shown in FIG. 2, and the servo device (2) and the reproducing device (2) move over a signal track (for example, an L channel) formed with an azimuth angle α2 shown in FIG. 2.

When a recording operation is carried out with recording devices of the magnetic head, the head change-over means 10 sends signals SI and S2 read from the servo devices (1) and (2) to reproduction/servo head amplifying means 20. Then, as illustrated in FIG. 4, the reproduction/servo head amplifying means 20 processes the signals S1 and S2 into signals S3 and S4, respectively, which are sent to a comparator circuit 21 installed in servo executing means 25. The comparator circuit 21 compares an output level (1) of the signal S3 from the servo device (1) and an output level (2) of the signal S4 from the servo device (2), and determines whether or not there is a difference between the output levels (1) and (2). If it determines that there is a difference, it sends a signal indicating the output difference to tape speed controlling means 18 to change the transport speed of the magnetic tape T.

When a signal is reproduced by the reproducing device (1) of the magnetic head, or when a signal is reproduced by the reproducing device (2) of the magnetic head, the head change-over means 10 performs a switching operation so that the signals S5 and S6 from the respective reproducing devices (1) and (2) are sent to the reproduction/servo head amplifying means 20. After the signals S5 and S6 have been processed by signal processing means 16 in the reproduction/servo head amplifying means 20, the processed signals are output as reproduction signals.

In the electrical circuit shown in FIG. 4, the reproduction/servo head amplifying means 20 processes the signals S1 and S2 read from the servo devices (1) and (2) during a recording operation, and processes the signals S5 and S6 read from the reproducing devices (1) and (2) during a reproducing operation. Therefore, when the electrical circuit shown in FIG. 4 is installed in the magnetic recording/reproducing apparatus of the present invention, a portion of a servo circuit can be used as a portion of a reproducing circuit. As a result, it is possible to reduce the number of electrical parts and to promote size reduction of the magnetic recording/reproducing apparatus.

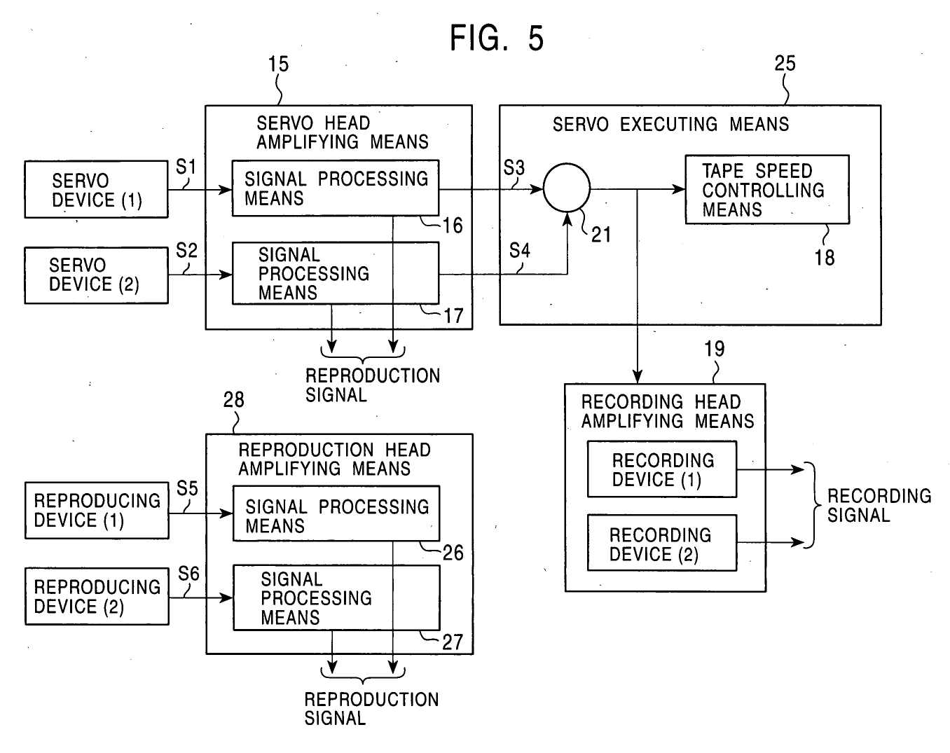

In FIG. 5, servo head amplifying means 15 and reproducing head amplifying means 28 are separately provided. The servo head amplifying means 15 processes signals Si and S2 read from servo devices (1) and (2) into signals S3 and S4 and sends them to a comparator circuit 21. The reproducing head amplifying means 28 processes signals S5 and S6 read from reproducing devices (1) and (2) into signals S5 and S6 and outputs them as reproduction signals. As shown in FIG. 5, the reproducing head amplifying means 28 comprises signal processing means 26 and 27. The signal processing means 26 processes the signal S5 read from the reproducing device (1) and outputs the processed signal as a reproduction signal. The signal processing means 27 processes the signal S6 read from the reproducing device (2) and outputs the processed signal as a reproduction signal.

In FIG. 5, when the signals S1 and S2 read from the servo devices (1) and (2) are recorded, the servo head amplifying means 15 processes the signals S1 and S2 and sends them to the comparator circuit 21 of servo executing means 25. When the signals S1 and S2 are reproduced, the signal processing means 16 and 17 can process the signals S1 and S2 and output the processed signals as reproduction signals. In other words, in a reproducing operation, the servo devices (1) and (2), as well as the reproducing devices (1) and (2), function as reproducing devices. As a result, if the electrical circuit shown in FIG. 5 is incorporated in the magnetic recording/reproducing apparatus of the present invention, it is possible to double the reproduction speed, to increase the transfer rate, and to improve error correction performance.

The electrical circuits shown in FIGS. 4 and 5 may also be used in a read after-write recording/reproducing apparatus. FIG. 7 shows a state in which read after-write magnetic heads H3, H4, H5, and H6 are mounted to a rotating head device 50. The magnetic heads H3 and H4 each comprise the recording device 2 and the servo device 3 shown in FIG. 1 and are used exclusively for a recording operation. The magnetic heads H5 and H6 each comprise the reproducing device 4 and are used exclusively for a reproducing operation. In the read after-write method illustrated in FIG. 7, the magnetic head H3 performs a recording operation on a magnetic tape T, the magnetic tape T further runs in the direction of an arrow which is marked beside the tape T, and a rotating drum rotates in the direction of an arrow which is marked beside the rotating drum. Then, the magnetic head H6 moves over the magnetic tape T, and the reproducing device of the magnetic head H6 reads a signal track that has been formed by recording a signal by the magnetic head H3. In the same way, next, the magnetic head H4 records a signal to form a signal track on the magnetic tape T, and, then, the reproducing device of the magnetic head H5 reads the signal track. These operations are repeated.

When the angle at which the magnetic tape T is wound upon the rotating drum is restricted so that the magnetic heads H3 and H6 do not move over the magnetic tape T shown in FIG. 7 at the same timing, only one of the heads is moving over the magnetic tape T at all times. In such a case, it is possible to use both of the electrical circuits shown in FIGS. 4 and 5.

When the magnetic head H3 comprises the servo device (1) shown in FIG. 4, the magnetic head H4 comprises the servo device (2), the magnetic head H6 comprises the reproducing device (1), and the magnetic head H5 comprises the reproducing device (2), connection to the reproduction/servo head amplifying means 20 can be switched by the head change-over means 10 each time the connection is to be changed, so that, after the servo device (1) reads and outputs a servo signal, the head change-over means 10 reads and outputs a signal from the reproducing device (1), and, then, a signal from the servo device (2), and, afterwards, a signal from the reproducing device (2).

However, when the angle at which the magnetic tape T is wound upon the rotating drum is restricted so that there is a time when the magnetic heads H3 and H4 move above the magnetic tape T at the same timing, the electrical circuit shown in FIG. 4 cannot be used, so that the electrical circuit shown in FIG. 5 is used. This is because, if there is a time when the magnetic heads H3 and H4 move at the same timing, when they move over the magnetic tape T at the same time, the connection to the reproduction/servo head amplifying means 20 cannot be switched by the head change-over means 10.

Since the servo devices need to be capable of detecting signals in correspondence with signal track widths, it is possible to allow the servo devices to move above a low-frequency servo area that is unaffected by data signals, or to simply detect an output level of a certain frequency region with the servo devices.

According to the present invention described in detail above, when a recording operation is performed on a magnetic recording medium, it is possible to stably record signals to form signal tracks with constant width using servo technology. Therefore, it is possible to reduce variations in reproduction signals compared to variations in the related art.

What is claimed is:

1. A magnetic head for recording signals to form adjacent signal tracks on a magnetic recording medium at different azimuth angles and for recording signals to form alternately-adjacent signal tracks on the magnetic recording medium at the same azimuth angle, the magnetic head comprising:
a recording device; and
a servo device disposed in parallel with the recording device in a direction in which the magnetic head moves over the magnetic recording medium,
wherein, while the recording device is recording a signal to form a signal track on the magnetic recording medium at a certain azimuth angle, the servo device moves over a signal track that has already been formed at the same azimuth angle as the certain azimuth angle by recording a signal.

2. A magnetic head according to claim 1, wherein the servo device moves over a signal track that has been formed by recording a first signal immediately before a current recording of a second signal on the magnetic recording medium by the recording device, the first signal being recorded by the same recording device used for the second signal that is currently being recorded.

3. A magnetic head according to claim 1, wherein the servo device is a magnetoresistive thin-film magnetic head.

4. A magnetic head according to claim 1, further comprising a reproducing device which overlaps the recording device in a thickness direction thereof.

5. A magnetic head according to claim 4, wherein the reproducing device is a magnetoresistive thin-film magnetic head.

6. A magnetic recording apparatus comprising:
a magnetic head, comprising a recording device and a servo device disposed in parallel with the recording device in a direction in which the magnetic head moves over the magnetic recording medium, for recording signals to form adjacent signal tracks on a magnetic recording medium at different azimuth angles and for recording signals to form alternately-adjacent signal tracks on the magnetic recording medium at the same azimuth angle;
servo amplifying means for processing and outputting a signal read from the servo device that has moved over a signal track in a certain recording operation, and for processing and outputting a signal read from the servo device in a currently carried out recording operation on the magnetic recording medium; and
servo executing means comprising a comparator circuit and a recording device movement position correcting means, the comparator circuit comparing levels of the outputs,
wherein, while the recording device is recording a signal to form a signal track on the magnetic recording medium at a certain azimuth angle, the servo device moves over a signal track that has already been formed at the same azimuth angle as the certain azimuth angle by recording a signal.

7. A magnetic recording apparatus according to claim 6, wherein the servo device moves over a signal track that has been formed by recording a first signal immediately before a current recording of a second signal on the magnetic recording medium by the recording device, the first signal being recorded by the same recording device used for the second signal that is currently being recorded.

8. A magnetic recording apparatus according to claim 6, wherein the servo device is a magnetoresistive thin-film magnetic head.

9. A magnetic recording apparatus according to claim 6, wherein the magnetic head further comprises a reproducing device which overlaps the recording device in a thickness direction thereof.

10. A magnetic recording apparatus according to claim 9, wherein the reproducing device is a magnetoresistive thin-film magnetic head.

11. A magnetic recording/reproducing apparatus comprising:
a magnetic head, comprising a recording device and a servo device disposed in parallel with the recording device in a direction in which the magnetic head moves over the magnetic recording medium, for recording signals to form adjacent signal tracks on a magnetic recording medium at different azimuth angles and for recording signals to form alternately-adjacent signal tracks on the magnetic recording medium at the same azimuth angle;
servo amplifying means for processing and outputting a signal read from the servo device that has moved over a signal track in a certain recording operation, and for processing and outputting a signal read from the servo device in a currently carried out recording operation on the magnetic recording medium; and
servo executing means comprising a comparator circuit and a recording device movement position correcting means, the comparator circuit comparing levels of the outputs,
wherein, while the recording device is recording a signal to form a signal track on the magnetic recording medium at a certain azimuth angle, the servo device moves over a signal track that has already been formed at the same azimuth angle as the certain azimuth angle by recording a signal, and
wherein, in a reproducing operation, a signal read from the reproducing device is sent to the servo amplifying means and is output as a reproduction signal from the servo amplifying means, so that the servo amplifying means is used, not only as a servo circuit, but also as a reproduction circuit.

12. A magnetic recording/reproducing apparatus according to claim 11, further comprising reproduction amplifying means, disposed separately from the servo amplifying means, for outputting the signal read from the reproducing device, wherein, in the reproducing operation, the reproduction amplifying means outputs the signal read from the reproducing device as a reproduction signal, and the servo amplifying means outputs the signal read from the servo device as a reproduction signal.

13. A magnetic recording/reproducing apparatus according to claim 11, wherein the servo device moves over a signal track that has been formed by recording a first signal immediately before a current recording of a second signal on the magnetic recording medium by the recording device, the first signal being recorded by the same recording device used for the second signal that is currently being recorded.

14. A magnetic recording/reproducing apparatus according to claim 11, wherein the servo device is a magnetoresistive thin-film magnetic head.

15. A magnetic recording/reproducing apparatus according to claim 11, wherein the magnetic head further comprises a reproducing device which overlaps the recording device in a thickness direction thereof.

16. A magnetic recording/reproducing apparatus according to claim 15, wherein the reproducing device is a magnetoresistive thin-film magnetic head.

17. A magnetic recording/reproducing apparatus according to claim 12, wherein the servo device moves over a signal track that has been formed by recording a first signal immediately before a current recording of a second signal on the magnetic recording medium by the recording device, the first signal being recorded by the same recording device used for the second signal that is currently being recorded.

18. A magnetic recording/reproducing apparatus according to claim 12, wherein the servo device is a magnetoresistive thin-film magnetic head.

19. A magnetic recording/reproducing apparatus according to claim 12, wherein the magnetic head further comprises a reproducing device which overlaps the recording device in a thickness direction thereof.

20. A magnetic recording/reproducing apparatus according to claim 19, wherein the reproducing device is a magnetoresistive thin-film magnetic head.
